(19) United States
(12) Patent Application Publication
(10) Pub. No.: US 2020/0346851 A1
(43) Pub. Date: Nov. 5, 2020

(54) SYSTEMS AND METHODS FOR REMOVAL AND COLLECTION OF FATS, OILS, AND GREASES FROM A RESIDENCE OR ESTABLISHMENT

(71) Applicant: Charles Walker, Union City, GA (US)

(72) Inventor: Charles Walker, Union City, GA (US)

(21) Appl. No.: 16/677,276

(22) Filed: Nov. 7, 2019

Related U.S. Application Data
(63) Continuation-in-part of application No. 15/721,733, filed on Sep. 29, 2017, now abandoned.
(60) Provisional application No. 62/401,551, filed on Sep. 29, 2016.

(51) Int. Cl. B65F 1/08; B01D 29/01; B65F 1/14

(52) U.S. Cl. CPC B65F 1/08; B01D 29/01; B65F 1/1452; B65F 2250/114; B65F 2240/152; B65F 2240/142; B01D 2201/265

(57) ABSTRACT

This disclosure relates to a system for the collection and removal of fats, oils, and greases (FOG) including a collection container including a sealable liner having a bag shape and configured to be inserted into the interior of the collection container and removable from the collection container. The system may also include a collection receptacle and a receptacle cover retractably attachable to the collection receptacle and configured to cover the top opening, a bag trough disposed within the receptacle interior, a filter screen to filter FOG, a liner basket contained in the collection interior configured to hold liner(s) for removal from the collection receptacle; a bag wiper configured to push the liner from the bag trough into the liner basket, and a tank heater configured to heat the receptacle interior.

### CROSS REFERENCE TO RELATED APPLICATIONS

This continuation in part application claims the benefit under 35 USC § 120 of U.S. application Ser. No. 15/721,733, filed on Sep. 29, 2017, which application claims the benefit under 35 USC § 119(e) of U.S. Provisional Application No. 62/401,551 filed on Sep. 29, 2016. U.S. application Ser. No. 15/721,733 and U.S. Provisional Application No. 62/401,551 are each incorporated herein by reference in their entireties.

### BACKGROUND OF THE DISCLOSURE

### Field of the Invention

This disclosure relates to implementations of systems and methods for the removal and collection of fats, oils, and/or greases (FOG) from residential and commercial buildings and establishments.

### Description of the Related Art

One of the biggest problems faced by municipalities and towns is the inclusion of fats, oils, and greases (FOG) into the sanitary sewer lines and storm sewer lines from residential buildings and homes. Most residences generate enough FOG such that, once aggregated, the amount of FOG generated by a neighborhood, subdivision, or apartment building is enough to create substantial issues in local plumbing and in sanitary sewage lines and water treatment systems. For municipalities, a reduction in the amount of FOG that is introduced into these sewer systems can significantly reduce the cost associated with maintaining sewer systems.

Furthermore, in recent years, the refining of FOG into biodiesel has taken on new importance as FOG can be more eco-friendly through recycling. Not long ago, restaurants paid to have their grease removed. Now, with the advent of biodiesel refineries, restaurants often sell their grease. An entire industry has developed around the collection of grease from commercial establishments. FOG is routinely collected from restaurants, hospitals, arenas, and the like. The FOG is then sold to the biodiesel refineries to produce recycled fuel.

At present, most municipalities use some form of drop off tank that residents can access at their local recycle center. There has been proposed a variety of ways to collect FOG from residential structures, such as single family homes and apartment buildings, however there is currently no systematic approach for collection. Collection of FOG from residential locations has always been fraught with problems associated with the transfer of the FOG to a collection tank or vehicle. These problems include spillage, staining, smell, and the attraction of rodents or other pests. Commercial establishments suffer the same problems of spillage, staining, smell, and pests with the collection of FOG. For example, stains from FOG are usually prevalent behind a restaurant. These stains are caused by spills that occur during the pumping or dumping of FOG from one container to another, or from the upsetting of one or more FOG collection tanks.

Given the disadvantages of disposing FOG in the sanitary sewer and storm sewer systems, and the advantages of recycling FOG, the collection of household FOG, considered in terms of sheer volume, is a huge, untapped prospective market. Creating a sanitary and simple system is very important for getting customers to participate in these types of recycle programs. Prior attempts have always been fairly complex, often requiring dumping and pumping of the FOG materials from one container to another container, which as discussed, causes substantial issues such as spilling and staining.

### SUMMARY OF THE INVENTION

This disclosure relates to a system for the collection and removal of fats, oils, and greases (FOG) incluing a collection container including a top configured to attach to the collection container with an air-tight seal, and a liner, that may be sealable, having a bag shape and configured to be inserted into the interior of the collection container and removable from the collection container. The system also may include a collection receptacle including a front side, a left side, a right side, a bottom side, a top opening, and a rear side, wherein the configuration of the front side, the left side, the right side, the bottom side, the top opening, and the rear side define a receptacle interior of the collection receptacle, a receptacle cover retractably attachable to the collection receptacle and configured to cover the top opening, a bag trough disposed within the receptacle interior adjacent to the top opening configured to catch the liner when inserted into the collection receptacle through the top opening and comprising a plurality of puncture members configured to puncture a liner on the bag trough, a filter to filter FOG which may comprise a screen, a liner basket contained in the collection interior configured to hold liner(s) for removal from the collection receptacle after the liner is punctured and drained of FOG on the bag trough; a bag wiper configured to be moved within the collection receptacle and configured to push the liner from the bag trough into the liner basket; and a tank heater configured to heat the receptacle interior. The tank heater may be included because during colder months the FOG may coagulate and solidify making the FOG impossible to pour from the container. Any filtering method that would effectively filter FOG is contemplated.

Other features and aspects will be apparent from the following detailed description, the drawings, and the claims

### BRIEF DESCRIPTION OF THE DRAWINGS

FIGS. 1A-1D illustrate an embodiment of a collection container.

FIGS. 2A-2D illustrate an embodiment of a collection receptacle.

FIGS. 3A and 3B illustrate an embodiment of a cover of a collection receptacle.

FIGS. 4A and 4B illustrate an embodiment of a bag trough of a collection receptacle.

FIGS. 5A-5D illustrate an embodiment of a liner basket of a collection receptacle.

FIGS. 6A-6C illustrate an embodiment of a bag wiper of a collection receptacle.

FIG. 7 illustrates an embodiment of a tank heater of a collection receptacle.

FIGS. 8A and 8B illustrate an embodiment of a collection receptacle mounted to a vehicle.

FIGS. 9A-9D illustrate an example use of a collection container.

FIGS. 10A-10F illustrate an example use of a collection receptacle.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, products, and/or systems, described herein. However, various changes, modifications, and equivalents of the methods, products, and/or systems described herein will be apparent to an ordinary skilled artisan.

Implementations of a system and methods for removal of fats, oils, and/or greases (FOG) and food waste are provided. The system for removal of fats, oils, and greases may comprise a collection container, a liner, and a collection receptacle. A method for removal of fats, oils, and greases may comprise placing a collection container at a location, inserting a liner into the collection container, collecting FOG into the liner, and collecting the FOG from the liner into the collection receptacle. The removal of FOG accordingly can be from any place that produces FOG, including commercial establishments and residential homes.

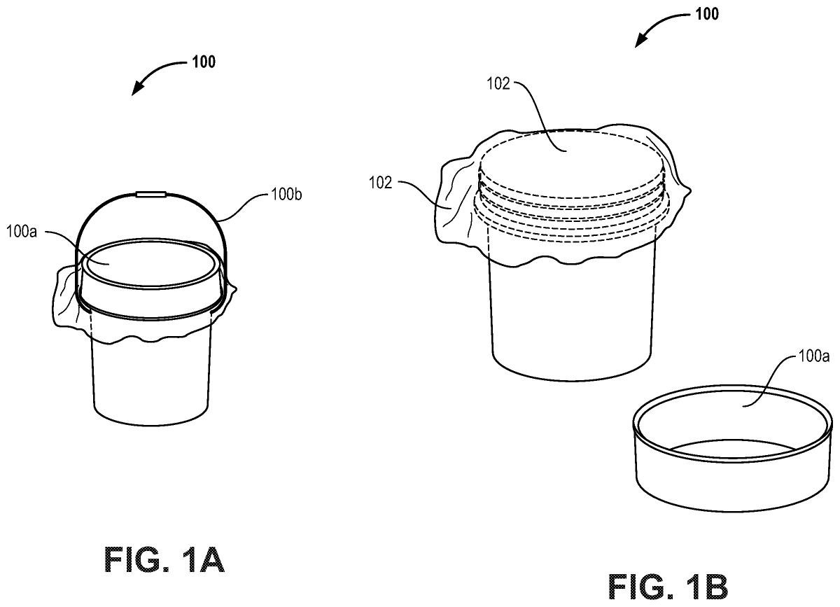

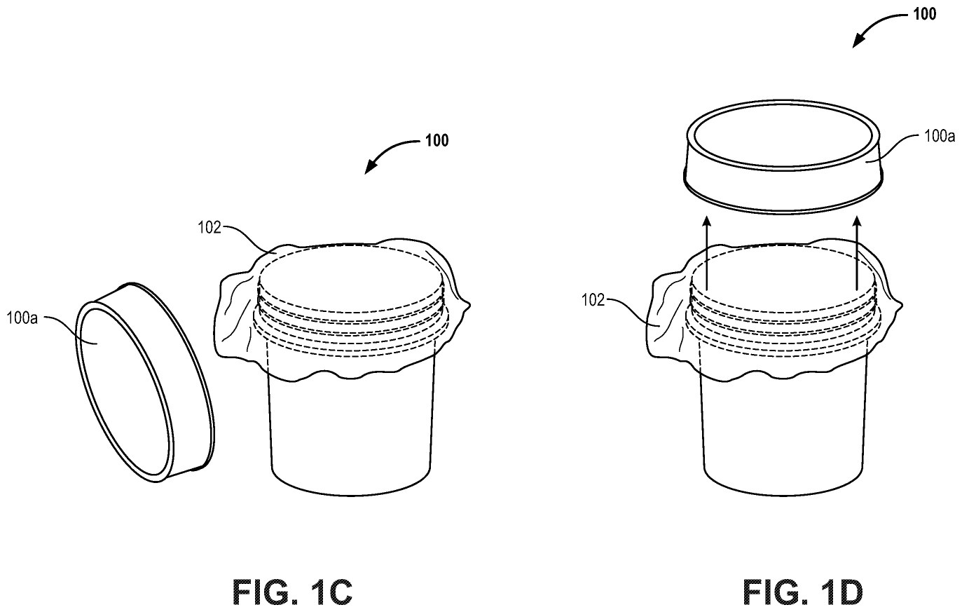

FIGS. 1A-1D illustrate an implementation of an example collection container 100. The collection container 100 may be configured to be placed in a location such as a commercial establishment or a residential home or apartment. The collection container 100 is configured to hold FOG collected at a location. The collection container 100 may be a plastic bucket-shaped container. The collection container 100 can have a variety of shapes and can be a variety of sizes. The collection container 100 comprises a top 100a that is configured to screw-on or otherwise attach to the collection container 100. The collection container 100 further comprises a handle 100b that can be configured to support the collection container 100 to carry or otherwise move the collection container 100.

A top 100a may be configured to contain the FOG and any related smells or odors within the collection container 100 when the top 100a is attached to the collection container 100. The top may provide an air-tight seal for the collection container 100. The top 100a may also be configured to protect the FOG from rodents or other pests when the top 100a is attached to the collection container 100 for example when the collection container 100 is placed at a curb side or other pickup location outside of an establishment.

A removable, disposable inner container or liner 102 may be inserted in the collection container 100 to contain the FOG for removal and disposal from the collection container 100. The liner 102 may be fillable, sealable, and puncturable. The liner 102 may be configured to be filled with FOG, sealed to contain the FOG, and punctured to transfer the FOG to a collection receptacle 200 (described further below) or other appropriate holding container. The liner 102 may have a bag shape configured to line the interior of the collection container 100 and drape through the opening over the exterior of the collection container 100. The liner 102 may be composed of a high temperature polymeric material. The liner 102 may be configured to hold FOG that has been heated from cooking or other uses.

The collection container 100 may be configured to hold and protect the liner 102 until the liner 102 is removed from the collection container 100 (e.g., by a waste handler) to be placed in the collection receptacle 200. The collection container 100 is configured to be placed outside of the location for collection of the sealed liner 102 containing FOG from the collection container 100 (e.g., by a waste hauler). In this way, the more fragile, puncturable material of the liner 102 is protected throughout the use and filling with FOG by the more durable collection container 100.

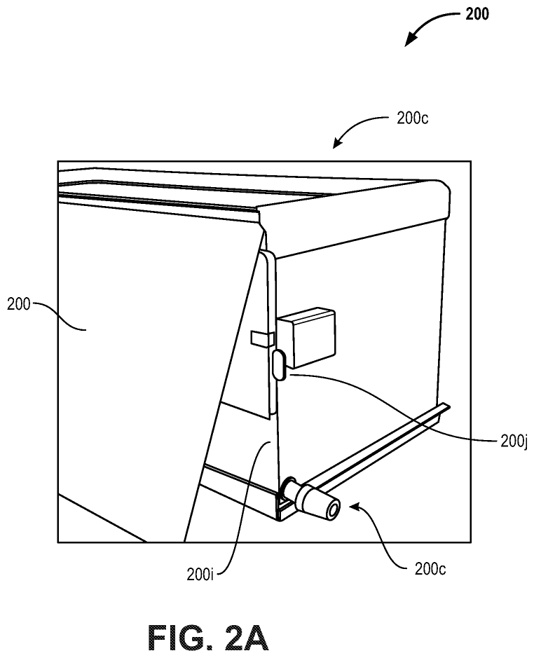

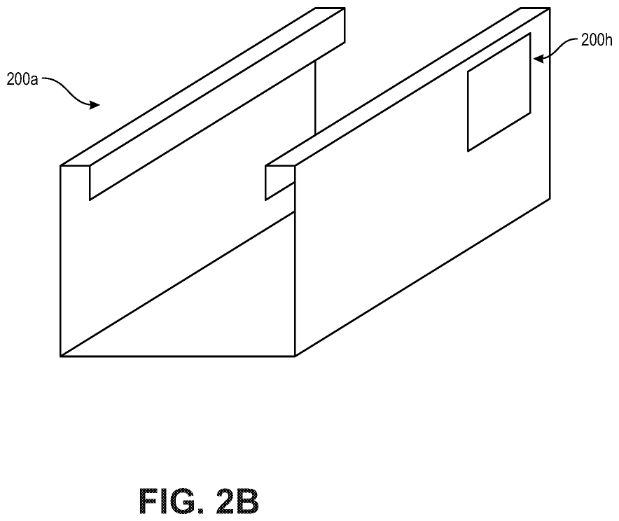

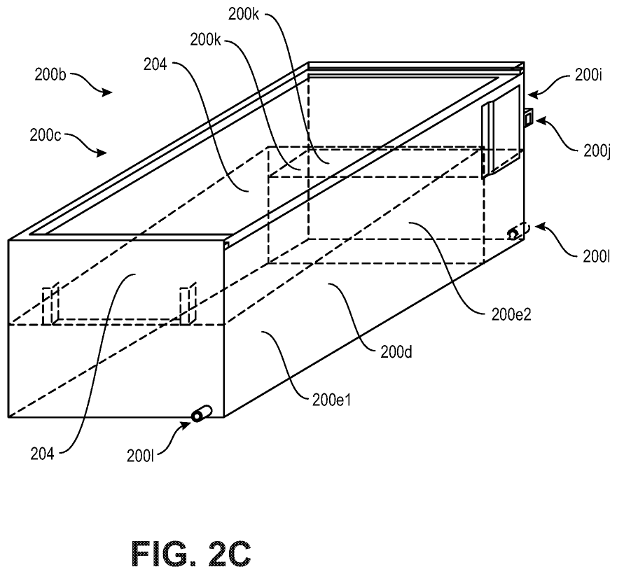

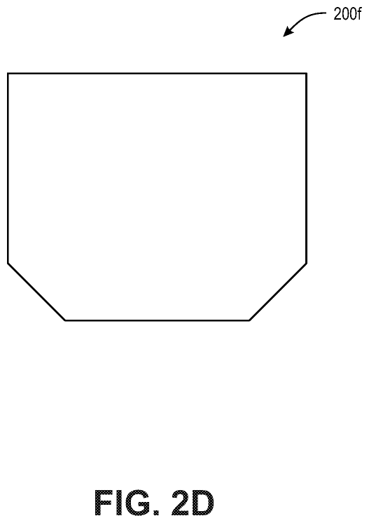

FIGS. 2A-2D illustrate an implementation of an example collection receptacle 200 according to the present disclosure.

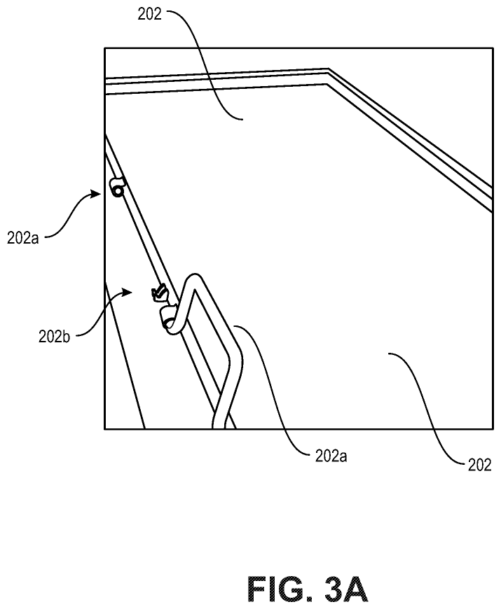

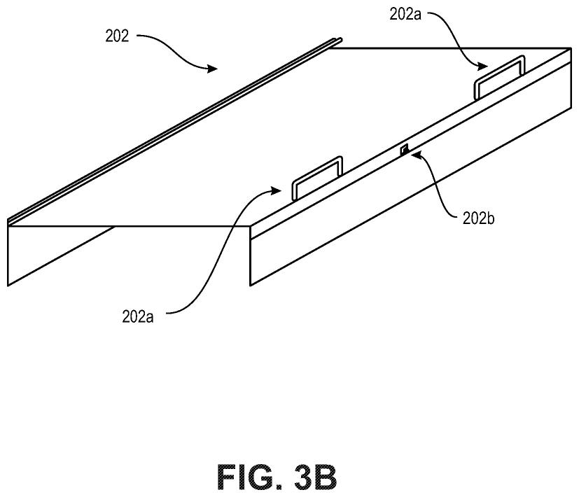

FIGS. 3A and 3B illustrate an implementation of an example cover 202 of the collection receptacles 200 according to the present disclosure.

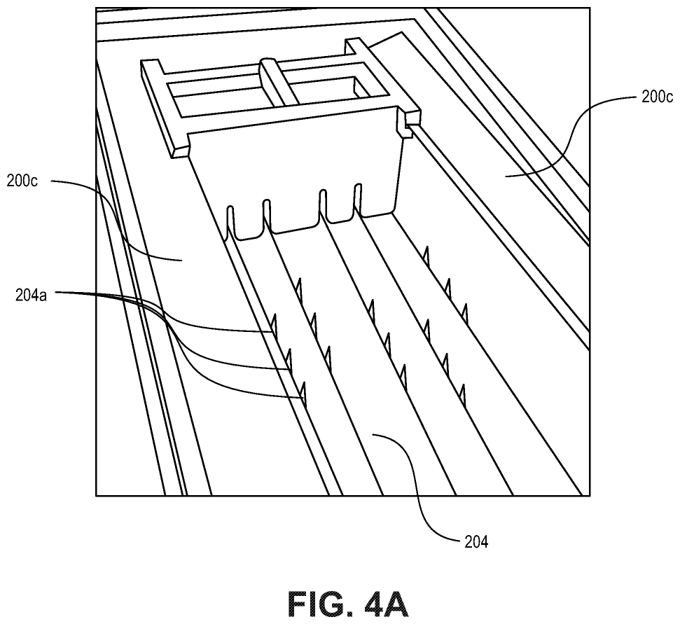

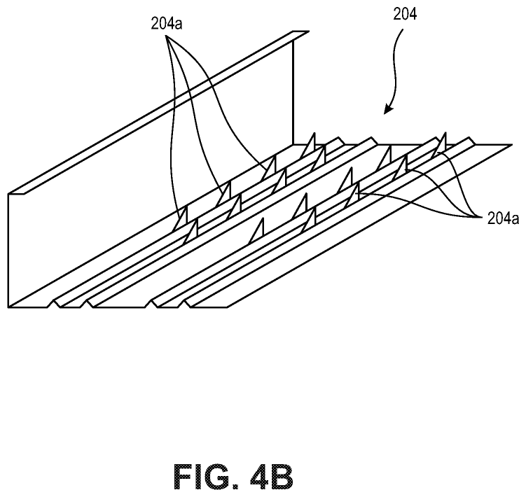

FIGS. 4A and 4B illustrate an implementation of an example bag trough 204 of the collection receptacle 200 according to the present disclosure.

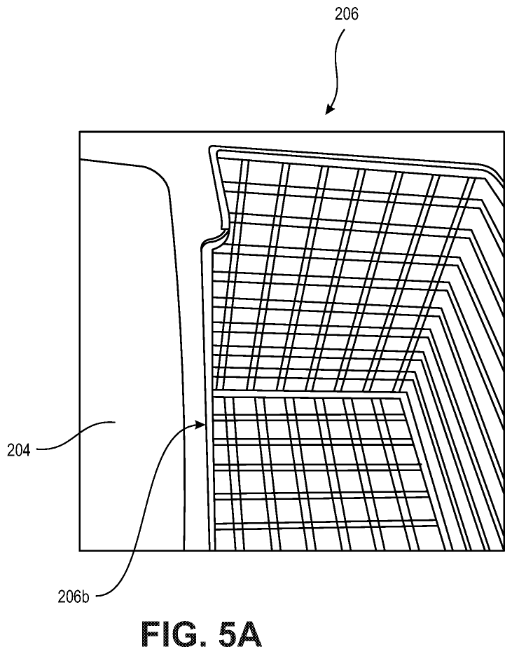

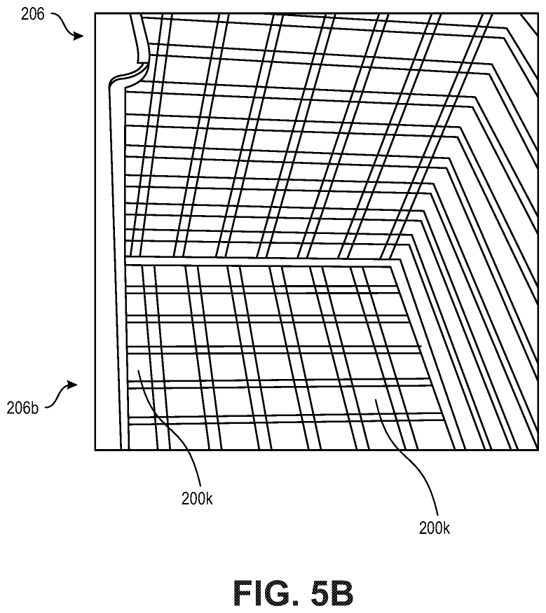

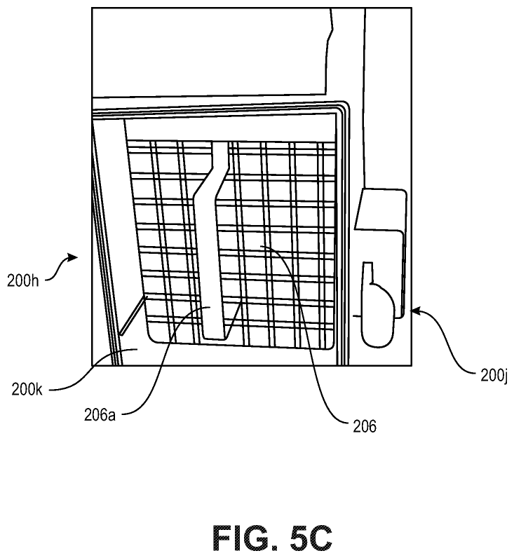

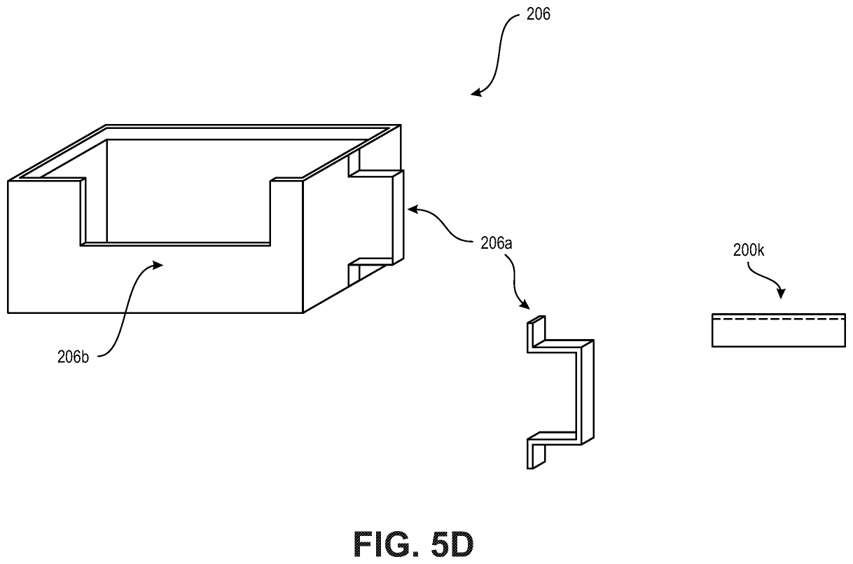

FIGS. 5A-5D illustrate an implementation of an example liner basket 206 of the collection receptacle 200 according to the present disclosure.

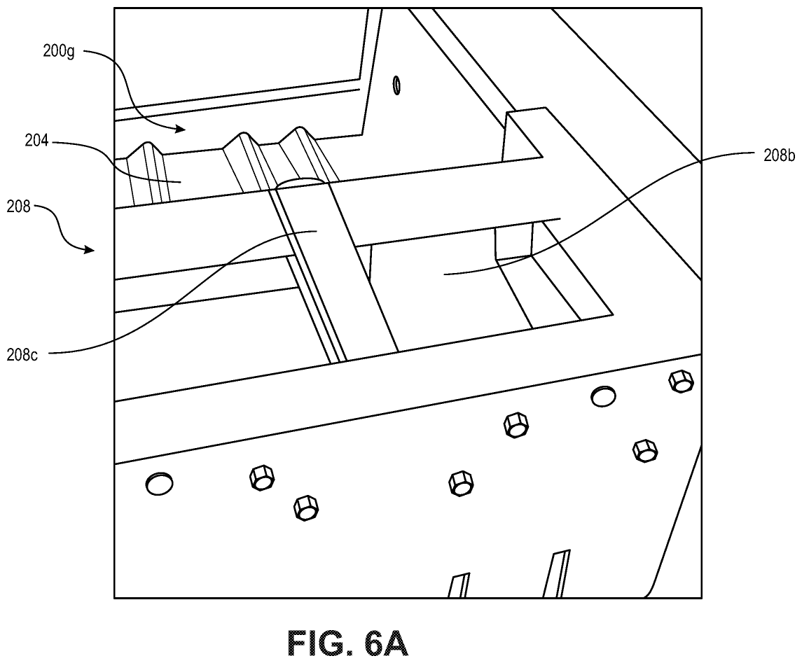

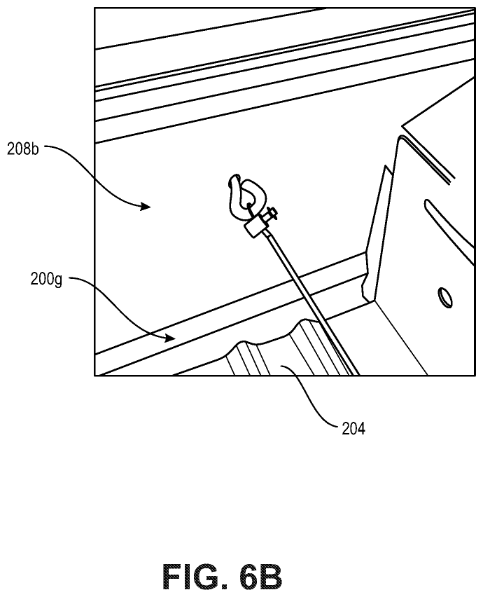

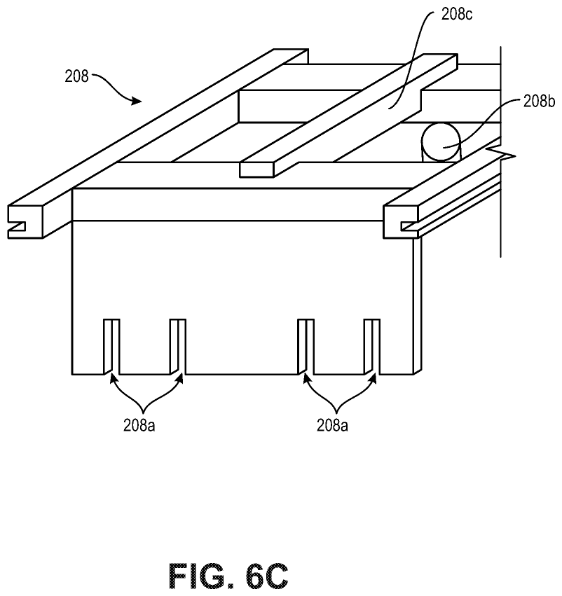

FIGS. 6A-6C illustrate an implementation of an example bag wiper 208 of the collection receptacle 200 according to the present disclosure.

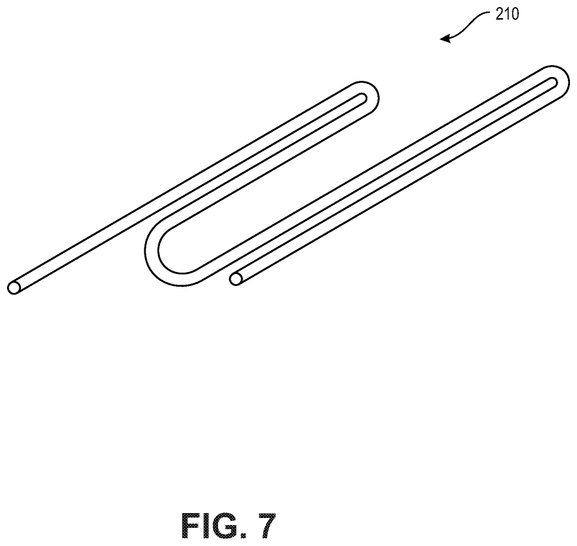

FIG. 7 illustrates an implementation of an example tank heater 210 of the collection receptacle 200 according to the present disclosure.

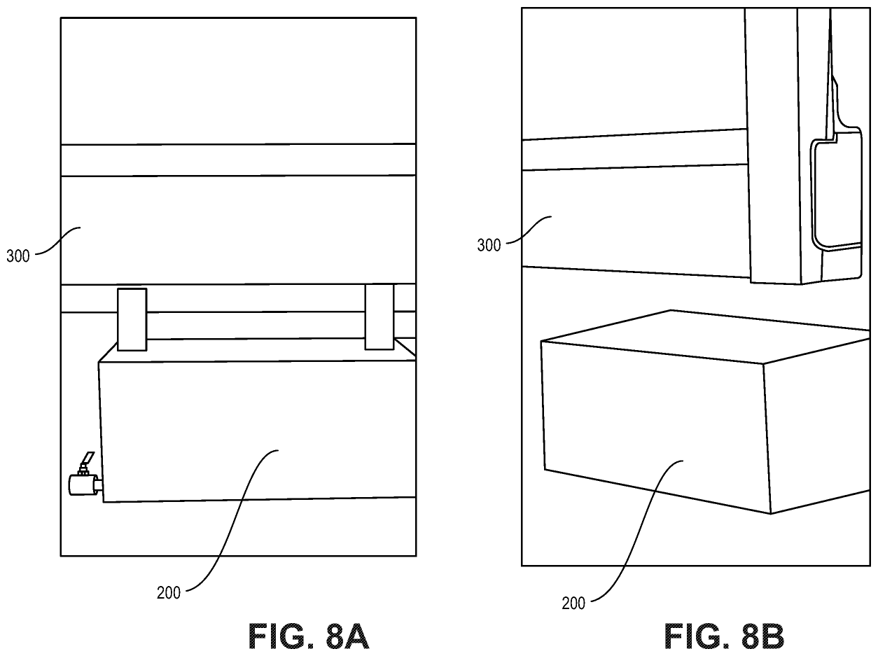

As shown in FIGS. 8A and 8B, the collection receptacle 200 may be a rectangular, box or tank shaped container. The collection receptacle 200 can have a variety of shapes and can be a variety of sizes. As shown in FIGS. 2B and 2C, the collection receptacle 200 may comprise an outer shell 200a and an inner shell 200b. The bottom interior or bottom 200d of a collection receptacle 200 under a bag trough 204 and liner basket 206 (described further below) may comprise one or more enclosures or tanks 200e1, 200e2.

The tanks 200e1, 200e2 may be configured to collect and hold FOG from liners 102 deposited in the collection receptacle 200. The tanks 200e1, 200e2 may include one or more baffles 200f. The baffles 200f may be configured to contain or otherwise prevent spillage of FOG from the tanks 200e1, 200e2.

As shown in FIGS. 3A and 3B, the collection receptacle 200 may also comprise a cover 202. The cover 202 may also be configured to be retractable. The cover 202 may be configured to partially or fully cover the FOG collected in the collection receptacle 200. The cover 202 may be configured to partially or fully cover the top opening 200c in the collection receptacle 200 including the bag trough 204 (described further below). The cover 202 is configured to seal closed. The closed cover 202 may be configured to prevent spillage or leakage of FOG from the collection container 200. The cover 202 may be configured to cover the FOG and/or the top opening 200c in the collection receptacle 200 when the collection receptacle 200 is being transported. The cover 202 may be configured to open and allow access to the FOG and/or the top opening 200c in the collection receptacle 200 when FOG is being collected and deposited into the collection receptacle 200.

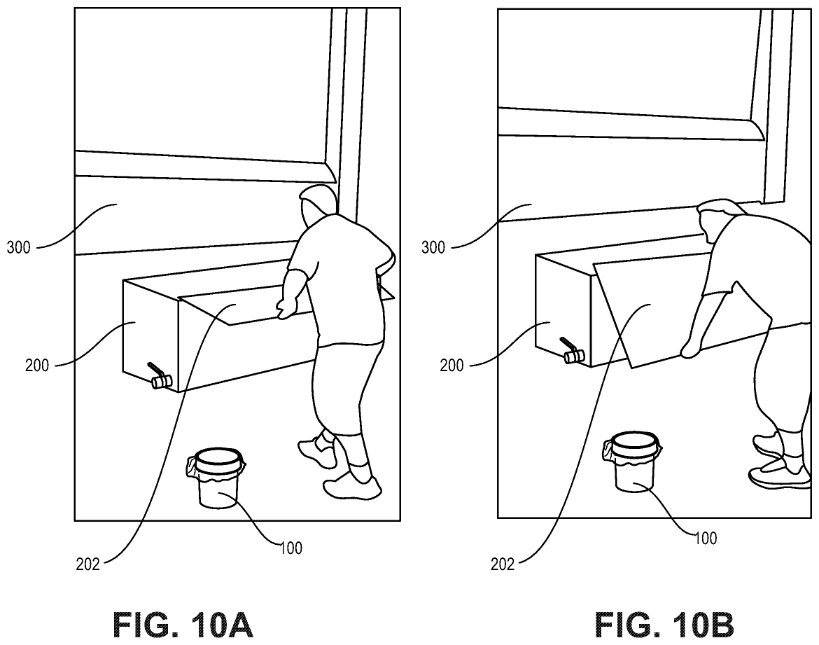

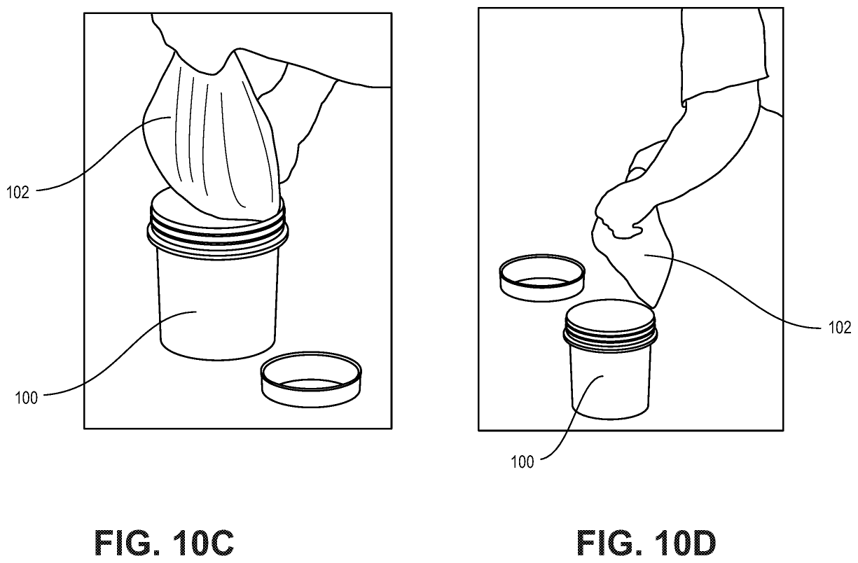

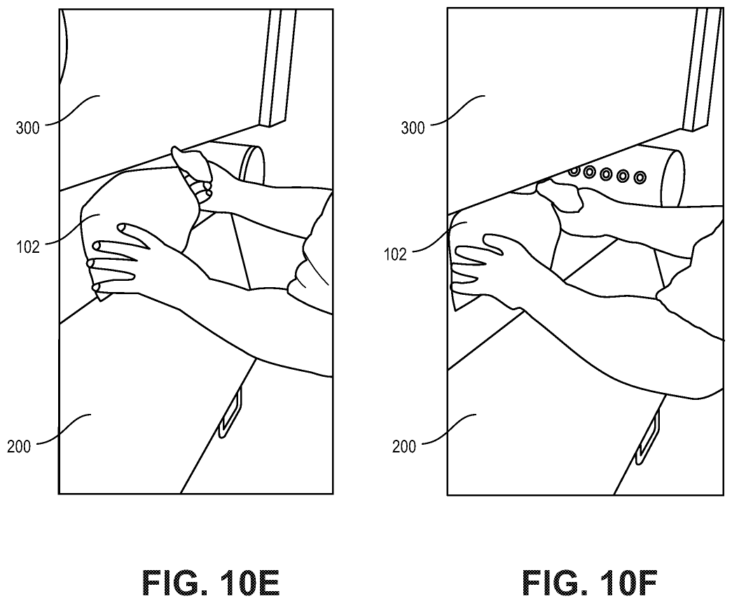

As shown in FIGS. 10A and 10 ft the cover 202 is configured to slide off of the top opening 200c and fold downward along a side of the collection receptacle 200. The cover 202 may be configured to cover and uncover the top opening 200c within limited clearance or space from other components of the collection vehicle 300 (described further below) such as a waste box or a holding tank. The cover 202 may comprise one or more handles 202a configured to assist to open or close the cover 202. The cover 202 may comprise one or more latching mechanisms 202b attached to the collection receptacle 200 and the cover 202 to keep the cover 202 closed over the top opening 200c.

As shown in FIGS. 4A and 4B, the collection receptacle 200 also comprises a screen or other retention shelf such as a bag trough 204. The bag trough 204 may be configured to catch the sealed liner 102 containing FOG when the liner 102 is deposited in the collection receptacle 200. The bag trough 204 may be configured so that the FOG from a punctured or otherwise ruptured liner 102 on the bag trough 204 will drain out, flow along or through the bag trough 204, and be collected in the bottom 200d of the collection receptacle 200 under the bag trough 204.

As shown in FIGS. 2C and 4B, the bag trough 204 may be configured with a downward incline or tilt from the liner basket 206 to the filter screen 200g (discussed further below). In this way, FOG released from liners 102 on the bag trough 204 flows down the incline of the bag trough 204 through the filter screen 200g into the bottom 200d of the collection receptacle 200. FOG released from liners 102 on the bag trough 204 may flow down the incline of the bag trough 204 through the filter screen 200g into the first tank 200e1 of the collection receptacle 200.

The collection receptacle 200 may also comprise one or more puncture members 204a. The puncture members 204a may comprise sharp-edged fin-shaped members that extend upward from the bag trough 204. The puncture members 204a may comprise cylindrical shaped members that are configured to allow FOG to drain from the liners 102 into the bottom 200d of the collection receptacle 200. The puncture members 204a may be configured to puncture liners 102 deposited in the collection receptacle 200. The puncture members 204a are configured to puncture the liners 102 when the liners 102 contact the puncture members 204a on the bag trough 204.

As shown in FIG. 4B, the bag trough 204 may comprise angled contours to allow FOG to drain under and past the liners and the puncture members 204a. The collection receptacle 200 may be configured to puncture deposited liners 102 that also contain food or other items with the FOG so that the FOG is drained from the punctured liners 102 without enough of the food or other items also being released to affect disposal or recycling of the FOG.

As shown in FIG. 6B, the collection receptacle 200 may also comprise one or more filters or filter screens 200g. The filter screen 200g may be configured to filter particles such as food or other items from the FOG as it drains across the bag trough 204 into the bottom 200d of the collection receptacle 200. The filter screen 200g may comprise a screen or mesh material. The filter screen 200g may comprise any other suitable material to filter out particles from the FOG.

As shown in FIGS. 5A-5D, the collection receptacle 200 may also comprise a bag or liner basket 206. The liner basket 206 may be configured to collect punctured and drained liners 102 that have been inserted into the collection receptacle 200. The liner basket 206 may be configured to collect the drained liners 102 for removal from the collection receptacle 200. The liner basket 206 may comprise a plurality of openings, such as a screen or mesh, configured to allow FOG to drain from punctured liners 102 into the bottom 200d of the collection receptacle 200. The openings in the liner basket 206 can have any suitable configuration that allows FOG to drain from the liners 102 into the bottom 200d of the collection receptacle 200. The liner basket 206 may be configured for the collected drained liners 102 to be removed by pulling out and/or removing the liner basket 206 from the collection receptacle 200. The liner basket 206 may comprise a handle 206a for pulling out and/or removing the liner basket 206 from the collection receptacle 200. The liner basket 206 may comprise a liner opening 206b configured to receive punctured and drained liners pushed from the bag trough 204 into the liner basket 206 through the liner opening 206b. The liner basket 206 may be removed from and inserted into the collection receptacle 200 through a basket opening 200h of the collection receptacle 200.

The basket opening 200h may be covered by a basket door 200i of the collection receptacle 200. The basket door 200i may be configured to open for access to the basket opening 200h. The closed basket door 200i may be configured to seal closed or otherwise prevent spillage of FOG from the collection receptacle 200 through the basket opening 200h.

The liner basket 206 may comprise a latching mechanism 200j attached to the collection receptacle 200 and the basket door 200i to keep the basket door 200i closed over the basket opening 200h. The liner basket 206 may be supported in the collection receptacle 200 on one or more basket supports 200k of the collection receptacle 200. The basket support 200k may be configured to support the liner basket 206 above the bottom 200d of the collection receptacle 200. The liner basket 206 may also be configured to allow FOG or other remaining content from punctured liners 102 to drain through the liner basket 206 into the bottom 200d of the collection receptacle 200. The liner basket 206 may be configured to allow the FOG or other remaining content from the punctured liners 102 to drain through the liner basket 206 into the second tank 200e2 of the collection receptacle 200.

As shown in FIGS. 6A-6C, the collection receptacle 200 may also comprise a bag wiper 208. The bag wiper 208 may be configured to move across the top opening 200c of the collection receptacle 200 adjacent to the bag trough 204. The bag wiper 208 may be configured to push liners 102 inserted into the collection receptacle 200 across the bag trough 204 into the liner basket 206. The bag wiper 208 may be configured to push the liners 102 across the bag trough 204 to thereby puncture the liners 102 by causing contact with the puncture members 204a. The bag wiper 208 may be configured to push liners 102 into liner basket 206 after liners 102 have been punctured and drained on bag trough 204. The bag wiper 208 may be configured to move across the top opening 200c of the collection receptacle 200 close to the bag trough 204 and over the puncture members 204a. The bag wiper 208 may comprise blade openings 208a configured to allow the puncture members 204a to pass through blade openings 208a when the bag wiper 208 passes over the puncture members 204a. The bag wiper 208 may also comprise a recoil unit 208b configured to retract the bag wiper 208 back to the initial position of the bag wiper 208 after the bag wiper 208 is pushed or otherwise moved across the collection receptacle 200 and the bag trough 204.

A recoil unit 208b may comprise a spring wound cable that is attached to the collection receptacle 200 on the side adjacent to the initial (or resting) position. The recoil unit 208b may comprise any other suitable components to retract the bag wiper 208 to the resting position. The bag wiper 208 may also comprise a handle 208c configured to be held to move or push the bag wiper 208 across the collection receptacle 200. The bag wiper 208 may be composed of fiberglass. The bag wiper 208 may be composed of a polymer material. The bag wiper 208 may be composed of any other suitable material.

The collection receptacle 200 may be configured to keep the collected FOG in a liquid form by heating or warming the collected FOG. The collection receptacle 200 may be configured to heat the FOG with a heating element such as a tank heater 210 as shown in FIG. 7. The tank heater 210 may be located below the bottom 200d of the collection receptacle 200. The heating element 210 can be any other suitable component configured to heat the FOG. The heating element 210 can be located in any other suitable location of the collection receptacle 200. The heating element 210 may be heated by the flow of a heated liquid through the heating element 210. The heating element 210 may be heated by the flow of a heated liquid (such as coolant) from the engine of the vehicle 300 through the heating element 210. The heating element 210 may be heated in any other suitable way.

As shown in FIGS. 2A and 2B, the collection receptacle 200 may also comprise one or more valved or otherwise regulated openings 200l at the bottom or lower portion 200d of the collection receptacle 200. The valved opening 200l may be configured to release the collected FOG from the collection receptacle 200, for example to transfer the FOG to a holding tank. The collection receptacle 200 may comprise a first valved opening 200l from the first tank 200e1. The collection receptacle 200 may comprise a second valved opening 200lfrom the second tank 200e2.

In some implementations, the collection receptacle 200 does not comprise a valved or similar opening, and the collection receptacle 200 is configured for the collected FOG to be pumped from the collection receptacle 200, for example to transfer the FOG to a holding tank.

The collection receptacle 200 may also comprise an abutted holding compartment (not shown). The holding compartment may be configured to hold liners 102 deposited in the collection receptacle 200 so that the held liners 102 are not punctured if, for example, the held liners 102 also contain food or other items that are not appropriate to comprise with the FOG for disposal or recycling.

FIGS. 8A and 8B illustrate an implementation of the collection receptacle 200 mounted to a vehicle 300 according to the present disclosure. The collection receptacle 200 can be attached or otherwise integrated to a collection vehicle 300. The collection vehicle 300 can be any suitable vehicle, such as a truck, van, car, etc. The collection receptacle 200 may comprise any suitable components for mounting to the collection vehicle 300. The collection receptacle 200 may be configured to be mounted to the collection vehicle 300 for collection of FOG in the liners 102 and removed from the collection vehicle 300 to be left at a location and later retrieved. For example, the collection receptacle 200 may be configured to be mounted to a collection vehicle 300 for collection of FOG from various locations and then removed from the collection vehicle 300 for removal of the FOG from the collection receptacle 200 for disposal, recycling, etc. The collection receptacle 200 may comprise any suitable components for mounting to and removing from the collection vehicle 300. The collection vehicle 300 can be a retrofit recycle or sanitation truck. The collection vehicle 300 can be an originally designed recycle or sanitation truck. The collection vehicle 300 can be any other suitable vehicle that comprises a collection system for FOG.

If the collection vehicle 300 is a retrofit recycle or sanitation vehicle, the collection receptacle 200 can be mounted between the frame and the existing waste box of the vehicle. The collection receptacle 200 can have any suitable dimensions to fit the available space for mounting to the collection vehicle 300. The collection vehicle 300 can be a commercial FOG collection vehicle that comprises a collection receptacle 200 for collection of FOG from a liner 102 and also a tank for collection of pumped or dumped FOG. The collection vehicle 300 can be an eco-friendly vehicle, such as a biodiesel fueled or electric powered vehicle, to reduce the carbon footprint for FOG collection using the collection container 100, liner 102, and collection receptacle 200. The collection receptacle 200 may comprise dimensions as shown in FIGS. 3B, 4B, etc. The collection receptacle 200 may also comprise any other suitable dimensions.

In some implementations, the collection container 100 and liner 102 comprises any suitable dimensions.

In some implementations, the collection receptacle 200, collection container 100, and liner 102 are composed of materials as described above.

In some implementations, the collection receptacle 200, collection container 100, and liner 102 are composed of any other suitable materials.

In some implementations, the collection receptacle 200, collection container 100, and liner 102 can have any suitable appearance.

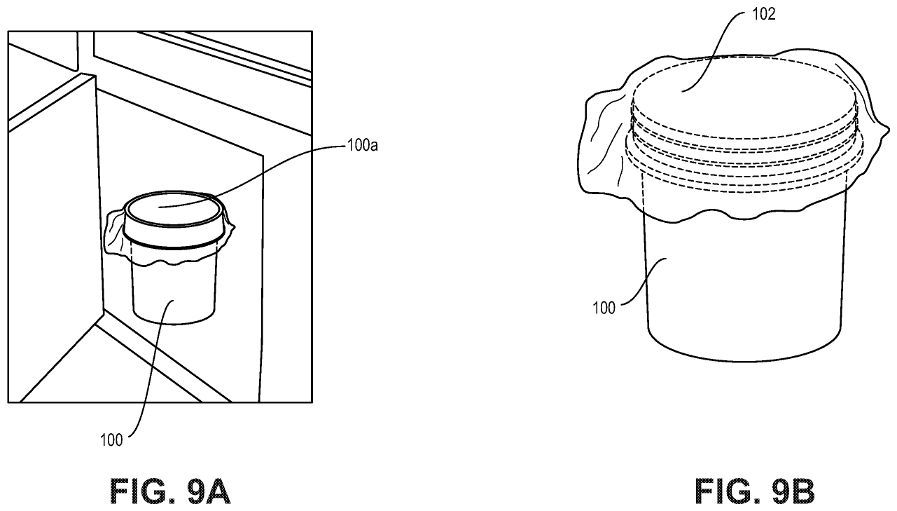

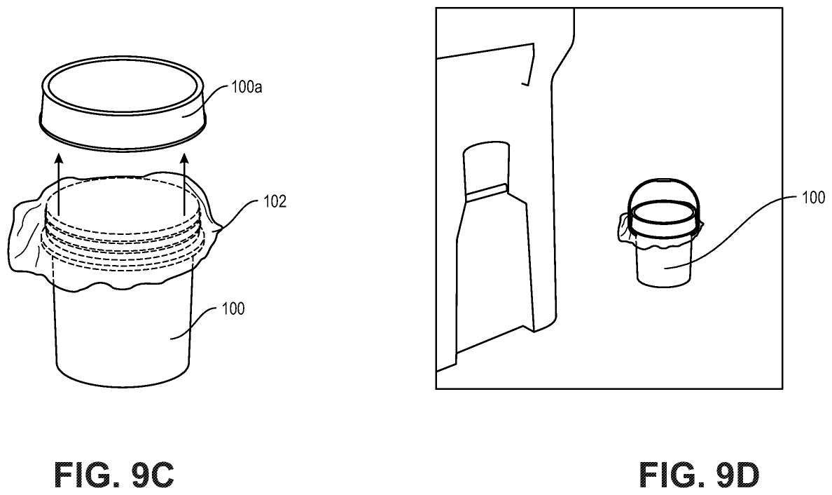

FIGS. 9A-9D illustrate an example use of a collection container 100 according to the present disclosure. An example use of the collection container 100 comprises placing the collection container 100 at a location where FOG is produced, such as a commercial establishment or a residential home or apartment. A liner 102 may be inserted in the collection container 100 to contain FOG for removal and disposal from the collection container 100. FOG may be inserted in the liner 102 within the collection container 100.

The top 100a may be attached to the collection container 100 to contain the liner 102, FOG, and any related smells or odors, and to protect the FOG from rodents or other pests. The liner 102 may be tied or otherwise sealed closed for the FOG to be picked up and removed from the location. The collection container 100 may be closed with the top 100a and containing the sealed liner 102 containing FOG placed outside the location (for example at a curb side) so that the FOG can be picked up for disposal, recycling, etc. by a collection service for waste, FOG, etc. The top 100a may be removed from the collection container 100 placed outside the location, the sealed liner 102 containing the FOG removed from the collection container 100, and the top closed back on the collection container 100 so the collection container can be taken back into the location and used again for inserting FOG using another liner 102.

FIGS. 10A-10F illustrate an example use of the collection receptacle 200 according to the present disclosure. An example use of the collection receptacle 200 comprises mounting the collection receptacle 200 on a collection vehicle 300. The collection receptacle 200 may be removably mounted to the collection vehicle 300. The collection receptacle 200 may be transported mounted to the collection vehicle 300 to locations to collect FOG from liners 102 removed from collection containers 200 left at the locations for FOG pickup and removal.

The collection receptacle 200 containing collected FOG from the liners 102 is transported mounted to the collection vehicle 300 to an appropriate disposal location where the FOG is removed from the collection receptacle 200 for disposal, recycling, etc. The collection receptacle 200 containing the collected FOG is removed from the collection vehicle 300 and left at a location to be retrieved later. In this way, FOG can be transferred from a production location to an appropriate disposal location without the FOG producer (such as a business employee or a home resident) or the FOG disposal handler having to come in to direct contact with the FOG.

An example use of the collection receptacle 200 comprises opening the cover 202 to allow access to the top opening 200c in the collection receptacle 200 to insert liners 102 for FOG collection. A liner 102 containing FOG may be picked up from a location and inserted in the collection receptacle 200 onto the bag trough 204 through the top opening 200c. One or more of the liners 102 inserted onto the bag trough 204 may be punctured by the puncture members 204a releasing the FOG from the liner 102 through or across the bag trough 204 and into the bottom 200d of the collection receptacle 200. The FOG released from the punctured liner 102 may flow down the incline of the bag trough 204 through the filter screen 200g into the first tank 200e1 of the collection receptacle 200.

The FOG in the one or more of the liners 102 inserted onto the bag trough 204 may be heated by the tank heater 210 to place or keep the FOG in a liquid form to allow the draining of the FOG from the liners 102 into the collection receptacle 200. The bag wiper 208 may be pushed across the bag trough 204 to move the punctured and drained liners 102 from the bag trough 204 into the liner basket 206 to collect the liners 102 together for holding or for removal from the collection receptacle 200 for disposal, recycling, etc. The bag wiper 208 may be pushed across the bag trough 204 to puncture or further puncture the one or more liners 102 inserted onto the bag trough 204 by causing contact with the puncture members 204a to release or further release the FOG from the liner 102 through or across the bag trough 204 and into the bottom 200d of the collection receptacle 200.

The pushing of the bag wiper 208 may move the punctured liners 102 across the bag trough 204 and into the liner basket 206 where the FOG or other remaining content can further drain from the liners 102 and the drained liners 102 are collected together for holding or for removal from the collection receptacle 200 for disposal, recycling, etc. The FOG or other remaining content may drain from the liners 102 through the liner basket 206 into the second tank 200e2 of the collection receptacle 200. The bag wiper 208 may be pushed back and/or retracted by the recoil unit back to the initial position of the bag wiper 208 to allow for more liners 102 to be inserted in the collection receptacle 200. The cover 202 may be closed over the top opening 200c of the collection receptacle 200 after FOG has been collected from the liners 102 from one or more pickup locations so the collected FOG can be transported in the collection receptacle 200 to a location for disposal, recycling, etc.

The liner basket 206 containing the drained liners 102 may be pulled out and/or removed from the collection receptacle 200, the liners 102 removed from the liner basket 206 for disposal, recycling, etc., and the liner basket 206 pushed back in and/or inserted to the collection receptacle 200. The basket door 200i may be opened to pull out and/or remove the liner basket 206 from the collection receptacle 200 through the basket opening 200h. The basket door 200i may be closed after the liner basket 206 is pushed back in and/or inserted to the collection receptacle 200 through the basket opening 200h.

The collected FOG may be removed from the collection receptacle 200 through the valved opening 2001 or pumped out of the collection receptacle 200. The FOG collected in the bottom 200d of the collection receptacle 200 may be heated by the tank heater 210 to place or keep the FOG in a liquid form to allow the removal of the FOG from the collection receptacle 200. In this way, the FOG can be appropriately disposed of separately from the liner 102 instead of being inappropriately disposed of together (e.g., in a landfill).

While this disclosure includes specific examples, it will be apparent after an understanding of the disclosure of this application has been attained that various changes in form and details may be made in these examples without departing from the spirit and scope of the claims and their equivalents.

What is claimed is:

1. A system for the collection and removal of fats, oils, and greases (FOG) and food waste comprising:
a collection container comprising:
a top configured to attach to the collection container with an air-tight seal; and
a sealable liner having a bag shape and configured to be inserted into the interior of the collection container and removable from the collection container; and
a collection receptacle comprising:
a front side, a left side, a right side, a bottom side, a top opening, and a rear side, wherein the configuration of the front side, the left side, the right side, the bottom side, the top opening, and the rear side define a receptacle interior of the collection receptacle;
a bag trough disposed within the receptacle interior configured to catch the liner when inserted into the collection receptacle through the top opening and comprising a plurality of puncture members configured to puncture a liner on the bag trough;
a filter;
a liner basket contained in the collection interior configured to hold liner(s) for removal from the collection receptacle after the liner is punctured and drained of FOG on the bag trough;
a bag wiper configured to be moved within the collection receptacle and configured to push the liner from the bag trough into the liner basket.

2. The system of claim 1, wherein the receptacle interior further comprises a first tank under the bag trough configured to receive and hold FOG that flows through the filter screen from the liner along the bag trough into the receptacle interior, and a second tank under the liner basket configured to receive and hold the remainder of the FOG that drains from the liner through the liner basket into the receptacle interior.

3. The system of claim 1, wherein the top for the collection container further comprises a container handle configured to support the collection container for moving and carrying the collection container.

4. The system of claim 1, wherein the collection container has a bucket shape.

5. The system of claim 1, wherein the collection receptacle has a rectangular shape.

6. The system of claim 1, wherein the puncture members comprise a plurality of sharp-edged fin-shaped members extending upward from the bag trough toward the top opening within the receptacle interior.

7. The system of claim 1, wherein the liner basket is configured to drain a remainder of FOG from the liner through the liner basket into the receptacle interior.

8. The system of claim 1, wherein the collection receptacle further comprises a basket opening through a side of the collection receptacle configured to allow the removal from and insertion of the liner basket to the receptacle interior.

9. The system of claim 8, wherein the basket opening comprises a basket door.

10. The system of claim 1, wherein the bag wiper comprises a plurality of openings configured to allow the puncture members to pass through the bag wiper when the bag wiper is moved; and the bag wiper comprises a recoil mechanism attached to the bag wiper configured to retract the bag wiper after the bag wiper is moved.

10. The system of claim 1, further comprising a tank heater that keeps the FOG in a liquid form.

11. The system of claim 1, wherein the collection receptacle further comprises a valved opening configured to allow the release of FOG from the receptacle interior.

12. The system of claim 1, wherein the collection receptacle is configured to be removably mounted to a waste collection vehicle.

13. The system of claim 12, wherein the collection receptacle is configured to be retrofitted and removably mounted to an existing waste collection vehicle.

14. The system of claim 1, further comprising a receptacle cover retractably attached to the collection receptacle and configured to cover the top opening.

15. The system of claim 1, wherein the filter comprises a screen.

16. A method of collecting and removing fats, oils, and greases (FOG) and food waste with the system of claim 1 comprising:
providing the collection container to a location that produces FOG;
providing a liner to insert in the collection container to fill with FOG and seal to contain the FOG;
transporting the collection receptacle to a location for removal of the FOG;
removing the sealed liner containing FOG from the collection container; and
depositing the liner removed from the collection container into the collection receptacle onto the bag trough; puncturing the liner on the bag trough with the puncture members to release FOG from the liner and drain FOG across the bag trough through the filter screen into the receptacle interior to collect and hold the FOG in the collection receptacle.

17. The method of claim 16, wherein the collection receptacle is removably mounted to a waste collection vehicle.

18. The method of claim 16, further comprising heating the FOG within the receptacle interior with the tank heater to place or keep the FOG in a liquid form.
